(19) United States
(12) Patent Application Publication
(10) Pub. No.: US 2009/0080660 A1
(43) Pub. Date: Mar. 26, 2009

(54) PROCESSORLESS MEDIA ACCESS CONTROL ARCHITECTURE FOR WIRELESS COMMUNICATION

(76) Inventors: Shih Mo, Milpitas, CA (US); Chung-Hsing Chang, Milpitas, CA (US); Ted Hsiung, Saratoga, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/858,540

(22) Filed: Sep. 20, 2007

(51) Int. Cl. H04L 9/08; H04L 9/06

(52) U.S. Cl. 380/279; 713/151

(57) ABSTRACT

To provide greater flexibility in wireless communication design and implementation, a device and method for implementing media access control (MAC) layer functionality without using an embedded processor for MAC layer functions. A key table stores connection identification data and communicates the connection identification data to a transmit control module and a receive control module to configure and control data transmission and reception, respectively. This use of dedicated hardware, rather than an processor, to implement MAC functions simplifies the design and construction of devices which wirelessly communicate with each other.

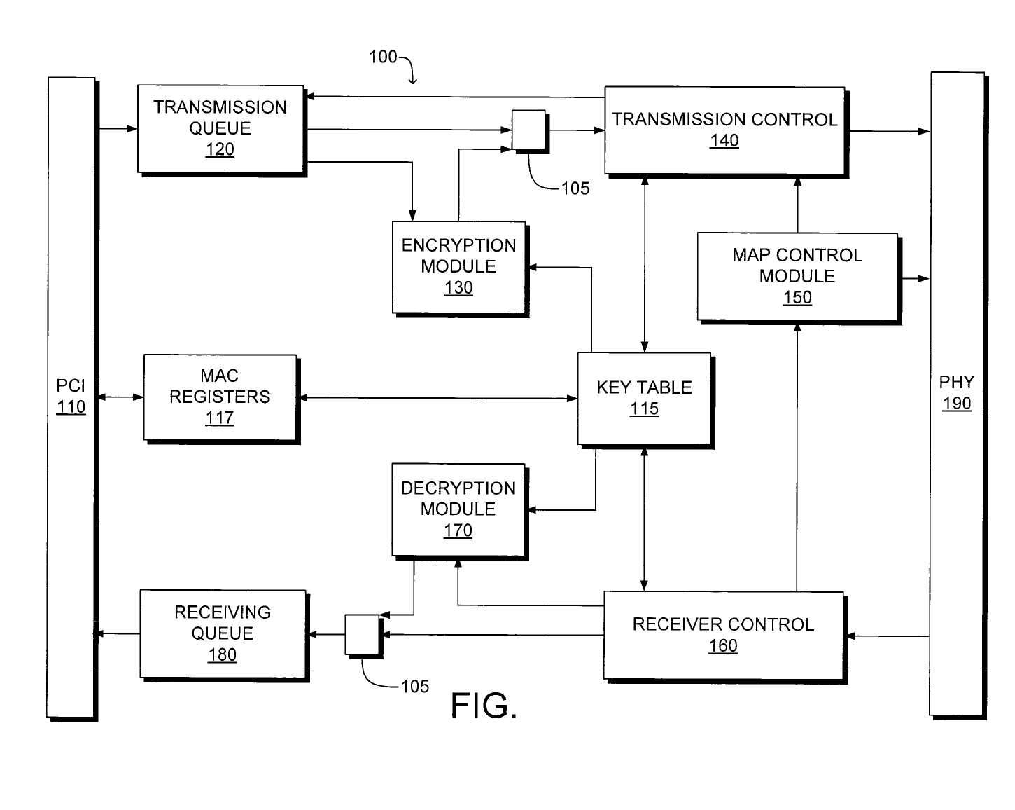

### BACKGROUND

1. Field of Art

The present invention generally relates to the field of wireless communication systems, and more specifically, to a device for implementing media access control (MAC) functions without an embedded processor.

2. Description of the Related Art

As the number of mobile communication devices, such as mobile phones, smartphones, personal digital assistants (PDAs) and handheld computers has increased, use of wireless networks to access and communicate data has also become more prevalent. This increased use of wireless communication has spurred advancements in wireless technology. One such advancement is the development of the IEEE 802.16 (“WiMAX”) standard which provides increased access to wireless communication.

The WiMAX standard uses central base stations with external antennas to provide network access, allowing access to wireless communication resources for large geographic areas, even areas where wired broadband access is impractical. Hence, the base stations provide point-to-multipoint access for broadband applications and provide high uplink and downlink bandwidth which is divided among multiple channels, each with multiple users. To control access to the transmission medium, the WiMAX standard implements media access control (MAC) on each mobile station or base station and uses a unique address to identify each mobile station or base station.

Hence, the MAC layer allows the same resources to be shared between multiple devices which can have different transmission requirements. For example, the MAC layer allows a base station to transmit and receive both constant bit rate traffic and burst traffic, as well as support multiple quality of service requirements for disparate types of traffic. Hence, the MAC layer allocates network resources to different mobile devices and configures data transfer between devices. Additionally, the MAC layer can also implement error detection and correction, connection establishment authentication, key exchange and data encryption.

However, conventional MAC layer implementation requires embedding a processor in the mobile device and/or the base station for MAC layer functions. This MAC-layer embedded processor increases device production cost. Because these devices are generally mobile, processor selection is restricted by power consumption, heat dissipation and other concerns.

Hence, there is a need for a device to implement MAC layer functionality without embedding a MAC-layer processor in a device.

### SUMMARY

Various embodiments of the invention allow implementation of media access control (MAC) layer functions without requiring an embedded MAC layer processor. Since wireless communication systems use MAC layer functions to regulate access to transmission media, implementing the MAC layer functions without a MAC layer processor simplifies the design and construction of devices which wirelessly communicate with each other. Additionally, implementing MAC functions without using embedded processor for MAC layer functionality allows for more flexibility in processor selection for a mobile device.

Generally, the following examples allow implementation of media access control (MAC) layer functions in a device without an embedded processor for performing MAC layer functions. For example, in one implementation, a key table is established using data from a general-purpose processor within the mobile device but external to the component implementing MAC functions, such as a connection identifier (CID) and an associated CID. A transmission control module communicates with the key table and allocates data for transmission based on the CID. A receiver control module also communicates with the key table and determines whether received data is associated with the stored connection identifier. This simplifies implementation of MAC layer functions by allowing certain functions to be implemented using dedicated hardware rather than by configuring a general purpose processor to perform MAC layer functions.

Other aspects of the invention include devices that implement MAC layer functionality without an embedded processor, components for these devices, and systems using these devices or techniques. Further aspects include methods and processes corresponding to all of the foregoing.

### BRIEF DESCRIPTION OF DRAWINGS

The disclosed embodiments have other advantages and features which will be more readily apparent from the following detailed description and the appended claims, when taken in conjunction with the accompanying drawing, in which:

The FIGURE is a block diagram of a processorless device for media access control (MAC) layer implementation according to one embodiment of the invention.

### DETAILED DESCRIPTION

The FIGURE and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention. It is noted that wherever practicable similar or like reference numbers may be used and may indicate similar or like functionality.

Generally, the following examples allow implementation of media access control (MAC) layer functions in a device without an embedded MAC layer processor. For example, in one implementation, a key table is established using data, such as a connection identifier (CID) and an associated key, from a processor external to the component implementing MAC layer functions. A transmission control module communicates with the key table and allocates data for transmission based on the CID. A receiver control module also communicates with the key table and determines whether received data is associated with the stored connection identifier. This simplifies implementation of MAC layer functions by allowing certain functions to be implemented using dedicated hardware rather than by configuring a general purpose processor to perform MAC layer functions.

The FIGURE shows a processorless device 100 for providing MAC layer functionality. The processorless device 100 includes a peripheral component interconnect (PCI) interface 110, a key table 115, media access control (MAC) registers 117, a transmission queue 120, an encryption module 130, a transmission control module 140, a map control module 150, a receiver control module 160, a decryption module 170, a receiving queue 180, a physical layer interface 190 and one or more selection modules 105.

The PCI interface 110 receives data describing one or more connection identifiers (CIDs) and keys associated with CIDs from an external processor and communicates the received data to the key table 115 via the MAC registers 117. According to one implementation, the PCI interface 110 formats data from the processor external to the component implementing MAC layer functions but within the mobile device into a specialized data structure including one or more control bits which facilitate data storage by the key table 115 and/or data retrieval from the key table 115. For example, the PCI interface 110 formats received data into a 32 bit data structure including bits specifying a data encryption format and bits identifying data within the key table 115 for decrypting the received data. In an implementation, this 32-bit data structure also includes data specifying the type of data received (e.g., ranging request, bandwidth request, protocol data unit or other suitable data type).

The key table 115 stores CIDs and/or MAC addresses, and keys associated with the CIDs and/or MAC addresses. In one design, the key table 115 comprises a flash memory device, a solid-state memory device or other suitable non-volatile storage device. In an alternative configuration, the key table 115 comprises a volatile storage device such as dynamic random access memory (DRAM), static random access memory (SRAM) or another suitable volatile data storage device. Alternatively, the key table 115 comprises a combination of a non-volatile storage device and a volatile storage device.

The MAC registers 117 store control data such as parameters controlling one or more MAC layer functions and/or data describing the status of one or more MAC layer functions or the processing of MAC data. Modifying data stored in the MAC registers 117 allows different MAC layer function to be disabled or modified to operate in a specified manner. In one configuration, the MAC registers 117 comprise a flash memory device, a solid-state memory device or other suitable non-volatile storage device. In an alternative configuration, the MAC registers 117 comprise a volatile storage device such as dynamic random access memory (DRAM), static random access memory (SRAM) or another suitable volatile data storage device. Alternatively, the MAC registers 117 comprise a combination of a non-volatile storage device and a volatile storage device.

The transmission queue 120 comprises a data storage device which stores Protocol Data Units (PDUs) or other data for transmission. In one design, the transmission queue 120 stores data in a first-in-first-out (FIFO) configuration so that the earliest received data or PDU is transmitted first. In one design, the transmission queue 120 comprises a flash memory device, a solid-state memory device or other suitable non-volatile storage device. Alternatively, the transmission queue 120 comprises a volatile storage device such as dynamic random access memory (DRAM), static random access memory (SRAM) or another suitable volatile data storage device or a combination of a non-volatile storage device and a volatile storage device.

The transmission control module 140 determines the timing of data transmission and the type of data transmitted. In one configuration, a state machine and one or more hardware gates are used to implement the transmission control module 140. In a system implementing the IEEE 802.16 standard (“WiMAX”) or similar wireless communication protocol, a base station, or other device, allocates resources among various mobile devices. The transmission control module 140 transmits a ranging request to the physical interface 190 which transmits the ranging request to the base station requesting resources for the mobile device. The transmission control module 140 then prevents data transmission from the mobile device until a response to the ranging request is received which specifies timing offsets and power adjustments for transmission. After establishing the timing offsets and power modifications, the transmission control module 140 configures one or more connections with the base station for data transmission, such as by requesting a bandwidth allotment for communication, exchanging keys for secure communication, transferring parameters or transmitting other configuration parameters. As the WiMAX or similar resource sharing implementation uses a scheduling algorithm, the ranging request and connection configuration determine when the mobile device transmits data and the amount of data transmitted. The transmission control module 140 compares a stored CID from the key table to CIDs received from a base station, and when the received CID matches the stored CID, data is transmitted.

When resources are available for data transmission, the transmission control module 140 selects data for transmission. The transmission control module 140 compares the size of each PDU or data element in the transmission queue 120 to the size of the resources available for transmission. If a PDU or data unit size is not greater than the allocated resources, the PDU or data unit is retrieved from the transmission queue 120 and communicated to the physical interface 190 by the transmission control module 140. If a PDU or data unit is larger than the resources allocated, the transmission control module 140 communicates null, or placeholder, data to the physical interface 190 and the PDU or data unit remains stored in the transmission queue 120 for later transmission. If there are no PDUs or data remaining for transmission, the transmission control module 140 also communicates null or placeholder data to the physical interface 190.

In another implementation where a system complies with the 802.11a/b/g/n or similar standard (“WiFi”), the transmission control module 140 determines when to transmit data by determining if the communication channel is currently transmitting data. Further, the transmission control module 140 maintains a temporal counter to allow scheduling of certain data, or data types, such as beacon PDUs, announcement traffic information message (ATIM) PDUs or other data.

The map control module 150 receives and decodes uplink-map (UL-MAP) and downlink map (DL-MAP) management messages and stores burst information corresponding to the received map. In one design, a state machine and one or more hardware gates are used to implement the map control module 150. In one configuration, the map control module 150 also maintains a downlink time counter associated with a received DL-MAP and an uplink time counter associated with a received UL-MAP. The downlink time counter determines the start time for the DL-MAP while the uplink time determines counts the start time for the UL-MAP. During a downlink, a mobile device receives data, so when a downlink burst start time is received, the map control module 150 transmits a control signal through the physical layer interface 190 to modify a downlink burst profile to improve data reception. During an uplink, data is transmitted from the mobile device so when an uplink burst start time is received, the map control module 150 specifies when the mobile device transmits data and modifies the uplink burst profile by transmitting a control signal through the physical layer interface 190.

The receiver control module 160 filters received PDUs or data using CID, MAC address or other identification data to reduce the workload of a host device or system. According to one configuration, one or more hardware gates and a state machine are used to implement the receiver control module 160. In one configuration, when a PDU, or other data, is received, the receiver control module 160 compares the CID of the PDU, or other data, with the CIDs, or other identifiers, stored in the key table 115. If the key table 115 includes a CID, or other identifier, which matches the CID, or other identifier, of the received PDU, the PDU, or other data, is communicated to the receiving queue 180 for storage and later communicated through the PCI interface 110 to a software process. If the key table 115 does not include a CID, or other identifier, matching the CID, or other identifier, of the received PDU, or data, the PDU, or data, is discarded. Alternatively, the receiver control module 160 compares a destination MAC address, or other destination identifier, of the PDU, or other data, with one or more MAC addresses, or other identifiers, stored in the key table 115 to determine if the PDU, or other data, is communicated to the receiving queue 180 or discarded.

In one design, the processorless device 100 also encrypts transmitted PDUs, or other data, and/or decrypts received PDUs or data. For example, an encryption module 130 is configured to perform Data Encryption Standard (DES) or Advanced Encryption Standard (AES) ciphers or other suitable encryption methods. In one implementation, the encryption module 130 is implemented by a state machine and one or more hardware gates. To implement encryption and/or decryption, the key table 115 associates a key with a CID, or other identifier, and also associates an index value with the key-identifier pair. When transmitted data is to be encrypted, the PCI interface 110 includes the index value of the appropriate key in the PDU, such as by setting a field or other component of a PDU or data unit to the index value. The PDU is communicated from the transmission queue 120 to the encryption module 130, where the identified key is retrieved from the key table 115 and used by the encryption module 130 to encrypt the PDU. The encrypted PDU is then transmitted to the transmission control module 140 for transmission through the physical interface 190. Hence, the encryption module 130 allows PDUs to be encrypted “on-the-fly” during transmission.

Similarly, the decryption module 170 allows decryption of received PDUs, or data, by applying DES, AES or similar decryption ciphers to the received data. In one implementation, the decryption module 170 is implemented by a state machine and one or more hardware gates. To decrypt data, the receiver control module 160 searches the key table 115 for a CID, MAC address or other identifier corresponding to the CID, MAC address or other identifier of the received PDU. If the key table 115 includes a CID, MAC address or other identifier that matches the received PDU, a key associated with the CID, MAC address or other identifier is retrieved and communicated to the decryption module 170, which decrypts the received PDU or data using the retrieved key. In one design, if the key table 115 does not include a CID, MAC address or other identifier corresponding to the received PDU, an error message, rather than the decrypted PDU or data, is transmitted to the receiving queue 180 for transmission through the PCI interface 110 to a software process.

The receiving queue 180 comprises a data storage device which stores received PDUs or other data for communication to a software process through the PCI interface 110. In one design, the receiving queue 180 stores data in a first-in-first-out (FIFO) configuration so that the earliest received PDU or data is transmitted first. In one design, the receiving queue 180 comprises a flash memory device, a solid-state memory device or other suitable non-volatile storage device. Alternatively, the receiving queue 180 comprises a volatile storage device such as dynamic random access memory (DRAM), static random access memory (SRAM) or another suitable volatile data storage device or a combination of a non-volatile storage device and a volatile storage device.

The physical interface 190 communicates data between the transmission control module 140, the map control module 150 or the receive control module 160 to the physical layer for communication to a base station or other device. The physical interface 190 converts data from a format used for implementing MAC functions to a second format suited for use by the physical layer. Also, the physical interface 190 converts received data from a physical layer format into a format suitable for evaluation by the receiver control module 160.

The selection module 105 generates a single output from a plurality of inputs. For example, a selection module 105 determines whether the transmission control module 140 receives data from the transmission queue 120 or from the encryption module 130. In one design, the selection module 105 comprises a multiplexer which outputs one of multiple inputs responsive to a control signal. Alternatively, the selection module 105 comprises a multiplexer which automatically selects one of the inputs as the output.

As used herein, “coupled” is intended to mean both coupled directly (without intervening elements) and coupled indirectly (with intervening elements). Upon reading this disclosure, those of skill in the art will appreciate still additional alternative structural and functional designs for a system and a method for implementing MAC functions without using an embedded processor. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A media access control (MAC) device comprising a first port for connecting to a physical (PHY) layer, a second port for connecting to a transport layer, and processorless circuitry coupled between the first port and the second port, the processorless circuitry implementing MAC functionality for wireless communication.

2. A device for implementing media access control (MAC) functionality without an embedded processor comprising:
a key table adapted to communicate with an external processor, for receiving a connection identifier (CID) and a key associated with the CID;
a transmission control module, adapted to communicate with the key table; for allocating data for transmission and wirelessly transmitting the allocated data; and
a receiver control module, adapted to communicate with the key table, for receiving data and determining whether the received data is associated with the CID.

3. The device of claim 1, further comprising:
a transmission queue, adapted to communicate with the transmission control module, for storing data to be transmitted prior to allocation for transmission.

4. The device of claim 1, further comprising:
a receiving queue, adapted to communicate with the receiver control module, for storing received data associated with the CID.

5. The device of claim 2, further comprising an encryption module, adapted to communicate with the transmission queue and the key table, for encrypting data to be transmitted using the key associated with the CID.

6. The device of claim 4, wherein the encryption module encrypts data to be transmitted by applying a Data Encryption Standard (DES) or an Advanced Encryption Standard (AES) cipher to the data to be transmitted.

7. The device of claim 3, further comprising a decryption module, adapted to communicate with the key table and the receiver control module, for decrypting received data associated with the CID.

8. The device of claim 6, wherein the decryption module decrypts received data associated with the CID by applying a Data Encryption Standard (DES) or an Advanced Encryption Standard (AES) cipher to the received data associated with the CID.

9. The device of claim 1, further comprising a peripheral component interconnect (PCI) interface, adapted to communicate with the key table, the transmission queue and the receiving queue, the PCI for communicating data between the key table, the transmission queue or the receiving queue and an external processor.

10. The device of claim 8, wherein the PCI interface formats data received from the external processor into a first format for storage by the key table.

11. The device of claim 1, further comprising a map control module for receiving and decoding an uplink-map message or a downlink-map message and for storing communication data associated with the uplink-map message or the downlink-map message.

12. The device of claim 1, further comprising a physical interface, adapted to communicate with the transmission control module and the receive control module, the physical interface for modifying a data format.

13. A device for implementing media access control (MAC) functionality without an embedded processor comprising:
means for receiving a connection identifier (CID) and a key associated with the CID;
means for transmission and transmitting the allocated data; and
means for receiving data and determining whether the received data is associated with the CID

14. The device of claim 12, further comprising means for storing data to be transmitted prior to allocation for transmission.

15. The device of claim 12, further comprising means for storing received data associated with the CID.

16. The device of claim 12, further comprising means for encrypting data to be transmitted using the key associated with the CID.

17. The device of claim 12, further comprising means for decrypting received data associated with the CID.

18. The device of claim 12, further comprising means for receiving and decoding an uplink-map message or a downlink-map message and storing communication data associated with the uplink-map message or the downlink-map message.

19. A device for implementing media access control (MAC) functionality without an embedded processor comprising:
a key table adapted to communicate with an external processor, for receiving a connection identifier (CID) and a key associated with the CID;
a transmission control module, adapted to communicate with the key table; for allocating data for transmission and transmitting the allocated data using a wireless data communication protocol; and
a receiver control module, adapted to communicate with the key table, for receiving data from the wireless data communication protocol and determining whether the received data is associated with the CID.

20. The device of claim 19, wherein the wireless data communication protocol is selected from the group consisting of the WiMAX standard and the WiFi standard.
